(19) United States
(12) Patent Application Publication
(10) Pub. No.: US 2018/0192200 A1
(43) Pub. Date: Jul. 5, 2018

(54) THIN SPEAKER DRIVER AND DIAPHRAGM THEREOF

(71) Applicant: KAI SHUAI INDUSTRIAL CO., LTD., Taipei City (TW)

(72) Inventor: I-Hsun Yu, Taipei City (TW)

(21) Appl. No.: 15/399,357

(22) Filed: Jan. 5, 2017

(51) Int. Cl. H04R 9/04; H04R 7/14; H04R 7/22; H04R 9/06

(52) U.S. Cl. CPC H04R 9/043; H04R 7/14; H04R 2400/11; H04R 9/06; H04R 7/22

(57) ABSTRACT

A thin speaker driver has a supporting frame, a magnet assembly, a voice coil assembly, a spider, a surround, and a diaphragm. The diaphragm is curved in radial section and has multiple coaxially arranged arc portions. A radial section of each arc portion has a curvature radius. The curvature radiuses of the radial sections of the arc portions are different from each other. Two of the arc portions that are disposed adjacent to each other are tangent to each other at which the two adjacent arc portions connect to each other. With the curvature variation of the radial section of the arc portions, different arc portions can be use to create sounds with different pitches. Accordingly, the speaker driver can create sounds with wide frequency responses to achieve full-range operation and thickness of the speaker driver can be greatly reduced, such that the speaker driver can be thinned.

### BACKGROUND OF THE INVENTION

### 1. Field of the Invention

The present invention relates to a speaker driver and a diaphragm of the speaker driver, especially to a speaker driver that is capable of being thinned and creating sounds with wide frequency responses.

### 2. Description of the Prior Art(s)

A loudspeaker includes an enclosure, at least one speaker driver, a divider, wires, terminals, and so on. Specifically, the loudspeaker may include a tweeter for reproducing high audio frequencies and a woofer for reproducing low audio frequencies. Otherwise, the loudspeaker may include a tweeter, a woofer, and a mid-range driver for reproducing middle audio frequencies, so as to create sounds with wide frequency responses to achieve full-range operation.

A conventional speaker driver of a moving coil loudspeaker includes a cone-shaped supporting frame, a magnet assembly, a voice coil assembly, a surround, and a cone-shaped diaphragm. The magnet assembly is mounted on a bottom of the supporting frame. The voice coil assembly is mounted around the magnet assembly and is electrically connected to the magnet assembly with voice coil. An outer peripheral edge of the cone-shaped diaphragm is attached to an outer peripheral edge of the supporting frame via the surround.

When an electrical signal is applied to the voice coil assembly, a magnetic field is created by electric current in the voice coil assembly, generating a mechanical force that causes the voice coil to move back and forth. Accordingly, the diaphragm attached to the voice coil assembly moves back and forth, pushing the air to create sound waves.

However, a range of frequency responses depends on a material of the cone-shaped diaphragm and a lower frequency extension depends on a depth of the cone-shaped diaphragm. The cone-shaped diaphragm has to deep enough, so as to allow the conventional speaker driver to have a proper lower frequency extension. Consequently, the conventional speaker driver is unable to be thinned and is unable to be used on a thinned loudspeaker.

To overcome the shortcomings, the present invention provides a thin speaker driver and a diaphragm of the thin speaker driver to mitigate or obviate the aforementioned problems.

### SUMMARY OF THE INVENTION

The main objective of the present invention is to provide a thin speaker driver. The speaker driver has a supporting frame, a magnet assembly mounted on a rear side of the supporting frame, a voice coil assembly mounted in the supporting frame, a spider mounted on the supporting frame and surrounding the voice coil assembly, a surround mounted on the supporting frame, and a diaphragm mounted between and attached to the spider and the surround. The diaphragm is curved in radial section and has multiple coaxially arranged arc portions. A radial section of each of the arc portions has a curvature radius. The curvature radiuses of the radial sections of the arc portions are different from each other. Two of the arc portions that are disposed adjacent to each other are tangent to each other at which the two adjacent are portions connect to each other.

With the curvature variation of the radial section of the arc portions, different arc portions can be use to create sounds with different pitches. Accordingly, the speaker driver can create sounds with wide frequency responses to achieve full-range operation and thickness of the speaker driver can be greatly reduced, such that the speaker driver can be thinned.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional side view of a thin speaker driver in accordance with the present invention, shown mounted in a speaker enclosure;

FIG. 2 is an enlarged cross-sectional side view of the thin speaker driver in FIG. 1;

FIG. 3 is a cross-sectional side view of a diaphragm of the thin speaker driver in FIG. 1; and

FIG. 4 is a cross-sectional side view of another embodiment of a diaphragm of a thin speaker driver in accordance with the present invention.

### DETAILED DESCRIPTION OF THE PREFERRED EMBODIMENTS

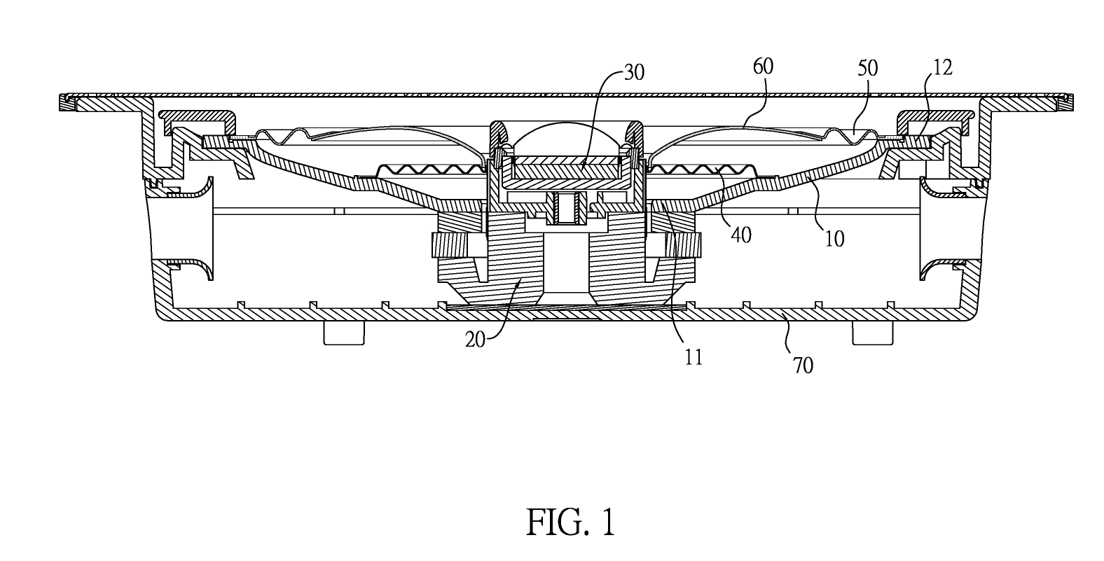

With reference to FIG. 1, a thin speaker driver in accordance with the present invention is mounted in a speaker enclosure 70 and includes a supporting frame 10, a magnet assembly 20, a voice coil assembly 30, a spider 40, a surround 50, and a diaphragm 60.

The supporting frame 10 is cone-shaped and flat, and has a front side, a rear side, an inner opening, an outer opening, an inner peripheral edge 11, and an outer peripheral edge 12. The front side of the supporting frame 10 is concave. The outer opening is larger than the inner opening in diameter. The inner peripheral edge 11 of the supporting frame 10 is defined around the inner opening. The outer peripheral edge 12 of the supporting frame 10 is defined around the outer opening.

The magnet assembly 20 is mounted on the rear side of the supporting frame 10 and corresponds in position to the inner peripheral edge 11 of the supporting frame 10.

The voice coil assembly 30 is movably mounted in the inner opening of the supporting frame 10 and has a voice coil. The voice coil is electrically connected to the magnet assembly 20.

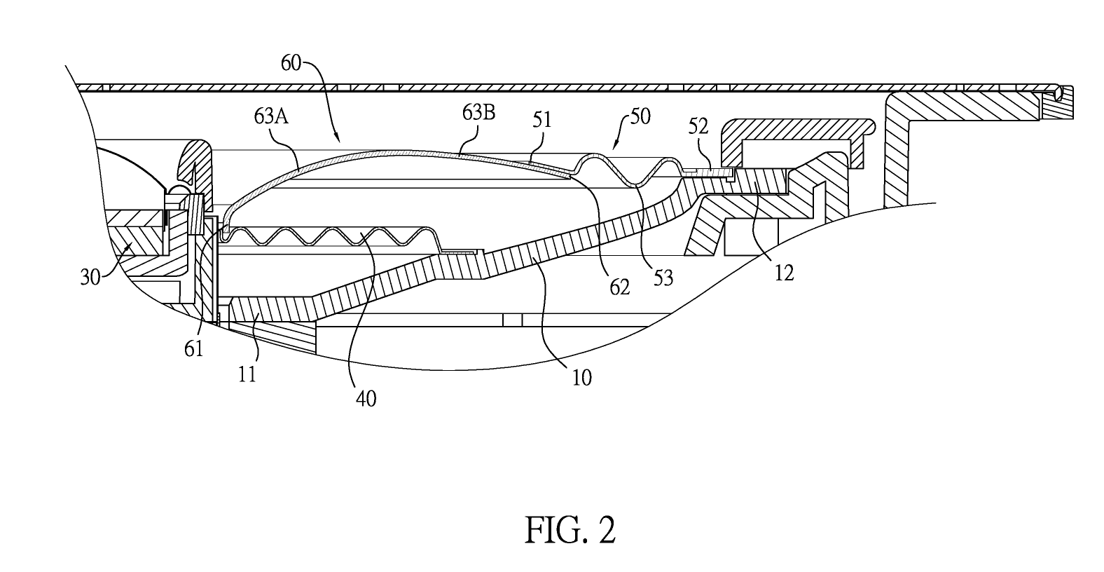

With further reference to FIG. 2, the spider 40 is annular, is corrugate in radial section, is mounted on the front side of the supporting frame 10, and surrounds the voice coil assembly 30. The spider 40 has an inner peripheral edge and an outer peripheral edge. The inner peripheral edge of the spider 10 is attached to the voice coil assembly 30. The outer peripheral edge of the spider 40 is attached to the supporting frame 10.

The surround 50 is annular, is disposed on the front side of the supporting frame 10, and is mounted on and around the outer peripheral edge 12 of the supporting frame 10. The surround 50 has an inner peripheral edge 51, an outer peripheral edge 52 and a corrugate portion 53. The outer peripheral edge 52 of the surround 50 is attached to the outer peripheral edge 12 of the supporting frame 10. The corrugate portion 53 is formed between the inner peripheral edge 51 of the surround 50 and the outer peripheral edge 52 of the surround 50, and is corrugate in radial section. Peak-amplitudes of the corrugate portion 53 decrease from the inner peripheral edge 51 of the surround 50 toward the outer peripheral edge 52 of the surround 50. Thicknesses of the corrugate portion 53 decrease from the inner peripheral edge 51 of the surround 50 toward the outer peripheral edge 52 of the surround 50.

The diaphragm 60 is annular, is curved in radial section, is mounted on the front side of the supporting frame 10, and is disposed between the voice coil assembly 30 and the surround 50. The diaphragm 60 has a convex surface, a collar 61, an outer edge 62, and multiple arc portions 63A, 63B. The convex surface of the diaphragm 60 faces toward the outer opening of the supporting frame 10. The collar 61 is attached to the inner peripheral edge of the spider 40. The outer peripheral edge 62 of the diaphragm 60 is attached to the inner peripheral edge of the surround 50. Accordingly, the diaphragm 60 is mounted above and covers the spider 40. The arc portions 63A, 63B are coaxially arranged between the collar 61 and the outer peripheral edge 62 of the diaphragm 60. Each of the arc portions 63A, 63B is annular. A radial section of each of the arc portion 63A, 63B is formed as an arc and has a curvature radius. The curvature radiuses of the radial sections of the arc portions 63A, 63B are different from each other. Two of the arc portions 63A, 63B that are disposed adjacent to each other are tangent to each other at which the two adjacent arc portions 63A, 63B connect to each other.

Preferably, the curvature radiuses of the radial sections of the arc portions 63A, 63B increase from the arc portion 63A that is disposed next to the collar 61 toward the outer peripheral edge 62 of the diaphragm 60. Specifically, the curvature radius of the radial section of the arc portion 63B that is disposed next to the outer peripheral edge 62 of the diaphragm 60 is larger than the curvature radius of the radial section of the arc portion 63A that is disposed next to the collar 61 of the diaphragm 60.

Preferably, thicknesses of the diaphragm 60 decrease from the collar 61 toward the outer peripheral edge 62 of the diaphragm 60. Each of the arc portions 63A, 63B has an inner sub-surface 631A, 631B and an outer sub-surface 632A, 632B. A curvature radius R2A, R2B of a radial section of the outer sub-surface 632A, 632B is larger than a curvature radius R1A, R1B of a radial section of the inner sub-surface 631A, 631B for one arc portion 63A, 63B.

In the preferred embodiment, the diaphragm 60 is made of plastic and is manufactured with a die by injection molding, so as to accurately control thickness variation of the diaphragm 60 and curvature variation of the radial sections of the arc portions 63A, 63B of the diaphragm 60.

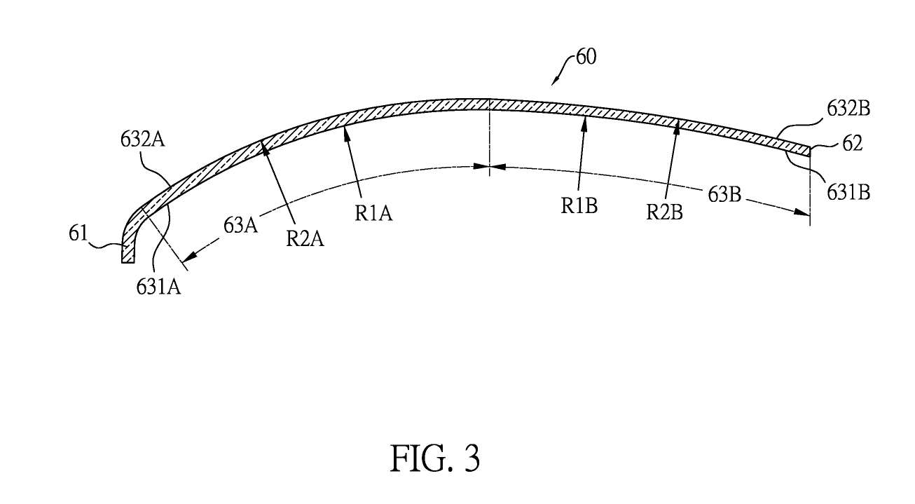

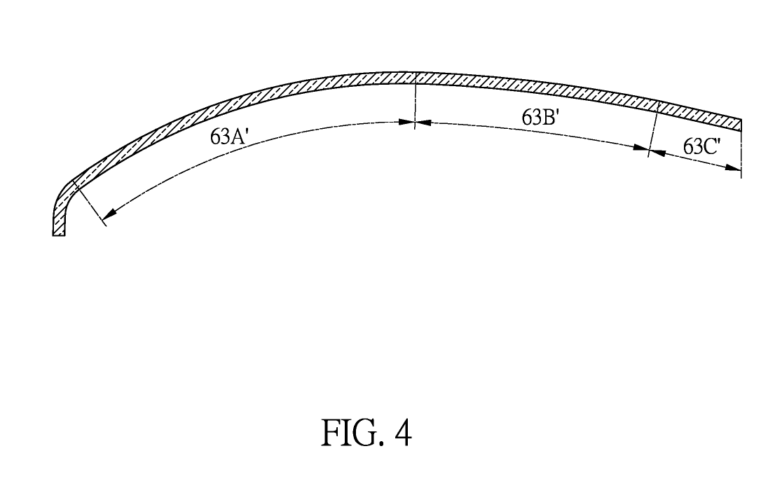

With reference to FIGS. 2 and 3, in the preferred embodiment, the multiple arc portions 63A, 63B include two arc portions 63A, 63B. With reference to FIG. 4, in another preferred embodiment, the multiple arc portions 63A′, 63B′, 63C′ include three arc portions 63A′, 63B′, 63C′.

The speaker driver as described as the following advantages. With the curvature variation of the radial section of the arc portions 63A, 63B and the thickness variation of the arc portions 63A, 63B, the arc portion 63A that is disposed closer to the collar 61 has thicker thickness and the radial section of the arc portion 63A that is disposed closer to the collar 61 has smaller curvature radius. The arc portion 63A that is disposed closer to the collar 61 can be applied to create sounds with high to medium pitches. The arc portion 63B that is disposed closer to the surround 50 has thinner thickness and the radial section of the arc portion 63B that is disposed closer to the surround 50 has larger curvature radius. The arc portion 63B that is disposed closer to the surround 50 can be applied to create sounds with low pitches. Accordingly, the speaker driver of the present invention can create sounds with wide frequency responses to achieve full-range operation.

Moreover, since range of the frequency responses of the speaker driver of the present invention is controlled by adjusting the thicknesses of the arc portions 63A, 63B of the diaphragm 60 and the curvature radiuses of the radial section of the arc portions 63A, 63B rather adjusting spatial dimension between the diaphragm 60 and the outer opening of the supporting frame 10. Therefore, thickness of the speaker driver can be greatly reduced, such that the speaker driver can be thinned.

Furthermore, with two of the arc portions 63A, 63B that are disposed adjacent to each other being tangent to each other at which the two adjacent arc portions 63A, 63B connect to each other, the radial sections of the arc portions 63A, 63B can extent to a continuous curve. Thus, the arc portions 63A, 63B of the diaphragm 60 do not perform out of phase sound waves, which cause timbre of the speaker driver to distort. The surround 50 being corrugate in radial section buffers movement of the diaphragm 60, such that low-frequency phase distortion under high power is avoided.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A speaker driver, including:
a supporting frame being cone-shaped and having
a front side being concave;
a rear side;
an inner opening;
an outer opening;
an inner peripheral edge defined around the inner opening; and
an outer peripheral edge defined around the outer opening;
a magnet assembly mounted on the rear side of the supporting frame and corresponding in position to the inner peripheral edge of the supporting frame;
a voice coil assembly movably mounted in the inner opening of the supporting frame and having a voice coil electrically connected to the magnet assembly;
a spider being annular, being corrugate in radial section, mounted on the front side of the supporting frame, and surrounding the voice coil assembly, and the spider having
an inner peripheral edge attached to the voice coil assembly; and
an outer peripheral edge attached to the supporting frame;
a surround being annular, disposed on the front side of the supporting frame, and mounted on and around the outer peripheral edge of the supporting frame, and the surround having
an inner peripheral edge;
an outer peripheral edge attached to the outer peripheral edge of the supporting frame; and
a corrugate portion formed between the inner peripheral edge of the surround and the outer peripheral edge of the surround, and being corrugate in radial section; and
a diaphragm being annular, being curved in radial section, mounted on the front side of the supporting frame, and disposed between the voice coil assembly and the surround, and the diaphragm having
a convex surface facing toward the outer opening of the supporting frame;
a collar attached to the inner peripheral edge of the spider;
an outer edge attached to the inner peripheral edge of the surround; and
multiple arc portions coaxially arranged between the collar and the outer peripheral edge of the diaphragm, and each of the arc portions being annular;
wherein
a radial section of each of the arc portions is formed as an arc and has a curvature radius, and the curvature radiuses of the radial sections of the arc portions are different from each other; and
two of the arc portions that are disposed adjacent to each other are tangent to each other at which the two adjacent arc portions connect to each other.

2. The speaker driver as claimed in claim 1, wherein the curvature radiuses of the radial sections of the arc portions increase from the arc portion that is disposed next to the collar toward the outer peripheral edge of the diaphragm.

3. The speaker driver as claimed in claim 2, wherein thicknesses of the diaphragm decrease from the collar toward the outer peripheral edge of the diaphragm.

4. The speaker driver as claimed in claim 3, wherein
each of the arc portions has
an inner sub-surface; and
an outer sub-surface; and
a curvature radius of a radial section of the outer sub-surface is larger than a curvature radius of a radial section of the inner sub-surface for one arc portion.

5. The speaker driver as claimed in claim 1, wherein peak-amplitudes of the corrugate portion of the surround decrease from the inner peripheral edge of the surround toward the outer peripheral edge of the surround.

6. The speaker driver as claimed in claim 2, wherein peak-amplitudes of the corrugate portion of the surround decrease from the inner peripheral edge of the surround toward the outer peripheral edge of the surround.

7. The speaker driver as claimed in claim 3, wherein peak-amplitudes of the corrugate portion of the surround decrease from the inner peripheral edge of the surround toward the outer peripheral edge of the surround.

8. The speaker driver as claimed in claim 4, wherein peak-amplitudes of the corrugate portion of the surround decrease from the inner peripheral edge of the surround toward the outer peripheral edge of the surround.

9. The speaker driver as claimed in claim 5, wherein thicknesses of the corrugate portion of the surround decrease from the inner peripheral edge of the surround toward the outer peripheral edge of the surround.

10. The speaker driver as claimed in claim 6, wherein thicknesses of the corrugate portion of the surround decrease from the inner peripheral edge of the surround toward the outer peripheral edge of the surround.

11. The speaker driver as claimed in claim 7, wherein thicknesses of the corrugate portion of the surround decrease from the inner peripheral edge of the surround toward the outer peripheral edge of the surround.

12. The speaker driver as claimed in claim 8, wherein thicknesses of the corrugate portion of the surround decrease from the inner peripheral edge of the surround toward the outer peripheral edge of the surround.

13. A diaphragm of a speaker driver being annular, being curved in radial section, and having
a collar;
an outer edge; and
multiple arc portions coaxially arranged between the collar and the outer peripheral edge of the diaphragm, and each of the arc portions being annular;
wherein
a radial section of each of the arc portions is formed as an arc and has a curvature radius, and the curvature radiuses of the radial sections of the arc portions are different from each other; and
two of the arc portions that are disposed adjacent to each other are tangent to each other at which the two adjacent arc portions connect to each other.

14. The diaphragm as claimed in claim 13, wherein the curvature radiuses of the radial sections of the arc portions increase from the arc portion that is disposed next to the collar toward the outer peripheral edge of the diaphragm.

15. The diaphragm as claimed in claim 14, wherein thicknesses of the diaphragm decrease from the collar toward the outer peripheral edge of the diaphragm.

16. The diaphragm as claimed in claim 15, wherein
each of the arc portions has
an inner sub-surface; and
an outer sub-surface; and
a curvature radius of a radial section of the outer sub-surface is larger than a curvature radius of a radial section of the inner sub-surface for one arc portion.
